(19) United States
(12) Patent Application Publication
(10) Pub. No.: US 2004/0181403 A1
(43) Pub. Date: Sep. 16, 2004

(54) CODING APPARATUS AND METHOD THEREOF FOR DETECTING AUDIO SIGNAL TRANSIENT

(76) Inventor: Chien-Hua Hsu, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/708,576

(22) Filed: Mar. 12, 2004

(30) Foreign Application Priority Data
Mar. 14, 2003 (TW) 092105702

(51) Int. Cl. G10L 19/02

(52) U.S. Cl. 704/230

(57) ABSTRACT

A coding apparatus includes a polyphase filter bank, a transient detector, and a coding processing unit. First, the coding apparatus performs a subband coding process according to an input signal to produce a plurality of subband samples, each subband sample having a plurality of frequency subbands. Following this, the coding apparatus performs a selection process to select a plurality of subband samples as reference sample data, and decides a block length of a window according to the energy sum of the frequency subband of the reference sample data in a predetermined frequency. Finally, the coding apparatus performs a transform process, according to the block length of the window decided in the selection process by a predetermined algorithm to transform the subband sample to an output signal.

### BACKGROUND OF INVENTION

1. Field of the Invention

The present invention relates to a coding apparatus, and more specifically, to a coding apparatus capable of detecting transients of audio signals. The coding apparatus of the present invention can also determine a window block length while adopting frequency domain coding technology.

2. Description of the Prior Art

At present, many coding apparatuses are based on different coding algorithms, such as MP3, AAC, WMA, and Dolby Digital™. These coding algorithms take into account the characteristics of the human auditory system, and have the advantage of high compression ratio (generally more than ten times). These coding apparatuses adopt perceptual coding, frequency domain coding, window switching, dynamic bit allocation technologies, etc to eliminate unnecessary content of the original audio data.

Perceptual coding eliminates audio data unperceivable by the human auditory system for reducing the size of the original audio data. Generally speaking, a human being can only hear audio signals having a frequency ranging from 20 Hz to 20 KHz, and therefore any audio signals out of this range are not perceivable. In addition, if the audio data have a signal eminent in volume or in tone, a human listener is not able to perceive other signals close to that sound. This phenomenon is referred to as auditory mask. Thus, it is unnecessary to code those unperceivable signals while coding the audio data.

Frequency domain coding transforms time domain data with high relativity into nearly irrelative frequency domains in order to eliminate unnecessary content of audio data. The frequency domain coding generally includes transform coding and subband coding. Transform coding has higher resolution while subband coding has lower resolution but higher efficiency. Therefore it is possible to combine these two kinds of coding methods to form a combined filter having different resolutions at different frequencies. However, the pre-echo effect is a problem in frequency domain coding. For instance, if the audio data contains sounds of rapidly increasing energy, quantization noise would increase. This results in the pre-echo effect. Both transform coding and subband coding suffer from the pre-echo effect, which occurs when the audio data is transformed back into the time domain.

A method, referred to as window switching, for eliminating the pre-echo effect is used to limit the error within a shorter period of time, so that the pre-echo effect are kept in the masking area. According to the window switching method, audio signals that are more stable are encoded with long windows, while signals including transients are encoded with short windows. However, the disadvantage of window switching is that more bits are required for storing audio data since the data needed to be encoded increases.

The quality of coding is greatly related to the allocation of bits in each subband. In order to allocate bits, it is necessary to analyze input signals continuously to allocate more bits into the subbands most perceivable by human beings, and allocate fewer bits into the subbands less perceivable. Since the signals change continuously, human begins have different reactions under different conditions. This is referred to as dynamic bit allocation technology. A good allocation relies on a precise psychoacoustic model.

FIG. 1 illustrates a conventional MPEG audio layer-3 signal coding method. First, a pulse code modulation (PCM) input signal 10 is divided into thirty-two frequency subbands of equal width by a polyphase filter bank 12. The polyphase filter bank 12 simply analyzes the relationship between frequency and time, but the frequency subbands of equal width cannot precisely reflect the characteristic of the human auditory system. In addition, neighboring frequency subbands have more overlapped parts so a modified discrete cosine transform (MDCT) 14 for compensation is required for the output of the polyphase filter bank 12. The MDCT 14 further divides the subbands for better spectrum resolution, and eliminates some overlapped parts generated by the polyphase filter bank 12. The MDCT 14 includes two windows of different block lengths, which are respectively an eighteen-sample long window and a six-sample short window. Since continuous windows are 50% overlapped, the length of the longwindow is actually thirty-six and the length of the short window is actually twelve. When the audio signals are stable, the long window has a higher frequency resolution and a better compression ratio, while the short window provides a better time resolution. Since the long window has a lower time resolution, if transients occur in the long window, the quantization noise will spread to the whole block. In this case, the signals with less energy will suffer from the quantization noise because of lower masking effect and therefore cause distortion, such as the pre-echo effect. To avoid the pre-echo effect, the conventional MPEG audio signal coding adopts a psychoacoustic model 16 to detect the transients of the audio signals, and then performs the MDCT 14 with short windows. After transforming the input signal 10 to the frequency domains by using frequency domain coding technology, a quantization process 18 is performed according to the psychoacoustic model 16. Then a packing process 20 is performed to pack the audio data and output a bit stream output signal 22.

The window switching technology is a typical way to avoid the pre-echo effect when performing frequency domain coding, and thus a mechanism of detecting transients of the audio signals is important. Conventional MPEG audio signal coding adopts the psychoacoustic model 16 to detect transients in the audio signals. Although the psychoacoustic model 16 is accurate, it is very complicated and has a higher cost as well. It is therefore not economical to adopt the psychoacoustic model 16 to detect transients of the audio signals in window switching.

### SUMMARY OF INVENTION

It is therefore one of the objectives of the claimed invention to provide a coding apparatus capable of detecting transients of audio signals. In addition, the claimed invention provides a coding apparatus and method thereof capable of determining window block length in frequency domain coding to solve the above-mentioned problems.

According to the claimed invention, a coding apparatus for coding an input signal to an output signal is provided. The coding apparatus includes a polyphase filter bank, a transient detector connected to the polyphase filter bank, and a coding processing unit connected to the polyphase filter bank and the transient detector. The polyphase filter bank is for producing a plurality of subband samples according to the input signal, wherein different subband samples correspond to the input signal in different time intervals, and each subband sample includes a plurality of frequency subbands. The transient detector is for determining a block length of a window including a plurality of weighted values. The transient detector includes a subband selector for selecting the plurality of subband samples as reference sample data, an energy calculator connected to the subband selector for calculating an energy sum of the frequency subbands of the reference sample data, a partition device connected to the subband selector and the energy calculator for dividing the reference sample data into several subsample data, each subsample data having at least a subband sample, and a comparator connected to the energy calculator for comparing an output value of the energy calculator with a first threshold value and outputting a signal representing the block length of the window according to the comparing result. The coding processing unit is for multiplying the plurality of frequency subbands by the plurality of weighted values of the window to produce a weighted result, and generating the output signal by a predetermined algorithm according to the weighted result.

The claimed invention further provides a method for coding an input signal to an output signal. The method includes: performing a subband coding process to produce a plurality of subband samples according to the input signal, different subband samples corresponding to the input signal in different time intervals, each subband sample having a plurality of frequency subbands; performing a selection process to provide a window of a predetermined block length, the window including a plurality of weighted values, the selection process including selecting a plurality of subband samples from the plurality of subband samples as reference sample data, and determining a block length of the window according to an energy of the frequency subbands of the reference sample data in a predetermined frequency range; and performing a transform process to multiply the plurality of frequency subbands by the plurality of weighted values of the window determined in the selection process for producing a weighted result, and to produce the output signal by a predetermined algorithm according to the weighted result.

These and other objects of the present invention will be apparent to those of ordinary skill in the art after having read the following detailed description of the preferred embodiment that is illustrated in the various figures and drawings.

### BRIEF DESCRIPTION OF DRAWINGS

FIG. 1 is a schematic diagram illustrating a conventional MPEG audio layer-3 signal coding method.

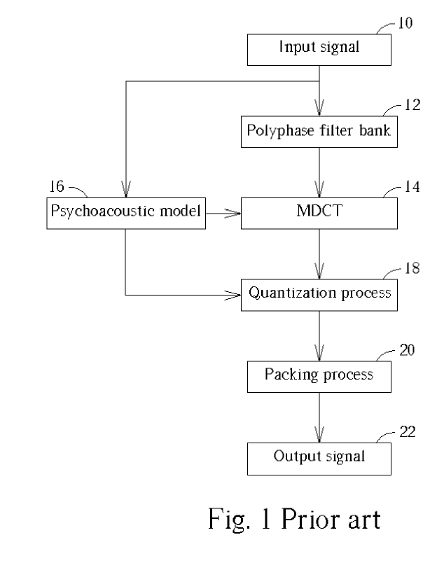

FIG. 2 is a schematic diagram of a coding apparatus according to an embodiment of the present invention.

FIG. 3 is a schematic diagram illustrating the subband samples.

FIG. 4 is a flowchart showing how the coding apparatus detects a transient according to another embodiment of the present invention.

### DETAILED DESCRIPTION

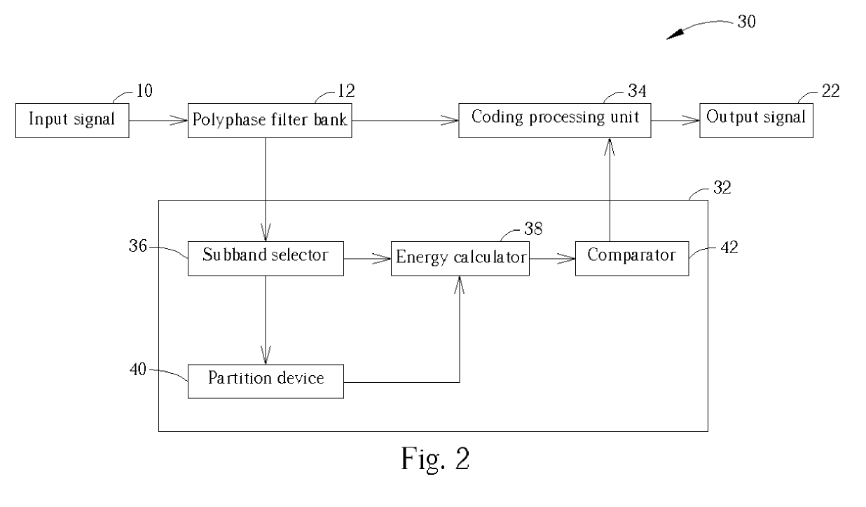

FIG. 2 illustrates a schematic diagram of a coding apparatus 30 according to an embodiment of the present invention. The coding apparatus 30 is for coding a pulse code modulation (PCM) input signal 10 to a bit stream output signal 22. The coding apparatus 30 includes a polyphase filter bank 12, a transient detector 32, and a coding processing unit 34. The polyphase filter bank 12 produces a plurality of subband samples according to the input signal 10. Different subband samples correspond to the input signal 10 in different time intervals, and each subband sample includes a plurality of frequency subbands. The coding processing unit 34 performs a modified discrete cosine transform (MDCT) to the plurality of frequency samples. The transient detector 32, which is connected to the polyphase filter bank 12 and the coding processing unit 34, can decide the block length of the window when the coding processing unit 34 performs the MDCT. The transient detector 32 includes a subband selector 36, an energy calculator 38, a partition device 40, and a comparator 42. The subband selector 36 selects a portion of the plurality of subband samples in a predetermined frequency range as a reference sample data. Then the energy calculator 38 calculates the energy sum of the reference sample data. Following that, the comparator 42 compares the energy sum of the reference sample data with a first threshold value. If the energy sum of the reference sample data is larger than the first threshold value, there is probably a transient existing in the reference sample data. In such case, the partition device 40 divides the reference sample data into several subsample data of equal width, each subsample data including at least a subband sample. Meanwhile, the energy calculator 38 calculates the energy difference of the frequency subband between two adjacent subsample data in a predetermined frequency range, and transfers the energy difference value to the comparator 42 to compare with a second threshold value. If the energy difference value is larger than the second threshold value, then the coding processing unit 34 perform the MDCT with short windows, otherwise it will repeat until the partition device 42 finishes all possible subsample data combinations. If the energy difference between two adjacent subsample data is still less than the second threshold value, then the coding processing unit 34 performs the MDCT with long windows.

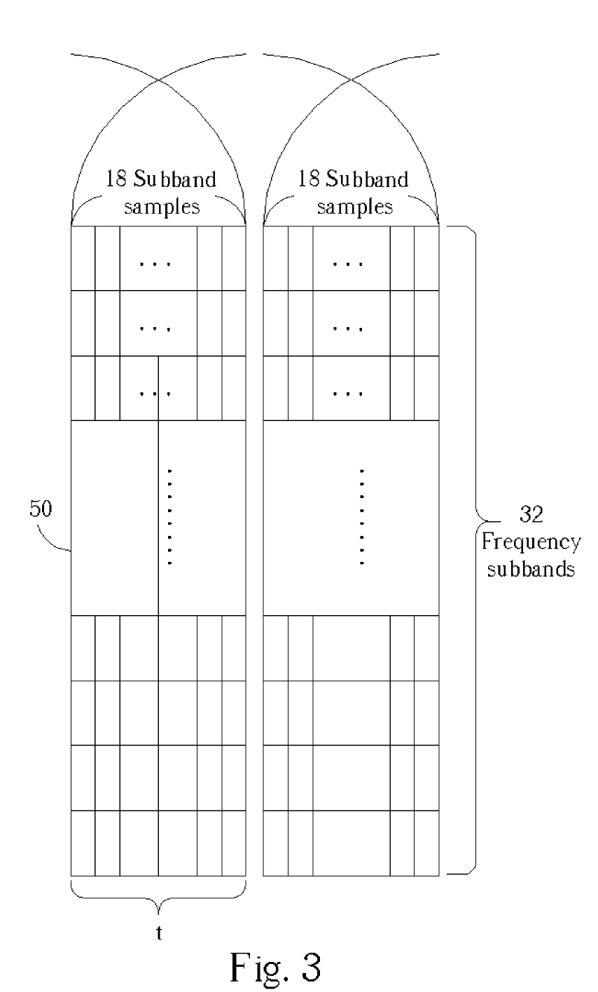

FIG. 3 illustrates a schematic diagram of the subband samples according to this embodiment. The polyphase filter bank 12 outputs eighteen subband samples during a time period “t”. Each subband sample includes thirty-two frequency subbands. The coding processing unit 34 performs the MDCT to each frequency subband in the overlapped section, i.e. thirty-six subband samples. The transient detector 32 detects where the transient occurs and the coding processing unit 34 performs the MDCT with either long windows or short windows. The predetermined frequency range normally means frequency between a start subband and a coding limit subband. The subband selector 36 selects a frequency subband in this frequency range as reference sample data 50. The start subband can be decided by experience or according to experimental results, and can be, for example, the first subband or a high frequency subband. In this embodiment, the frequency of the start subband is about 4 kHz. On the other hand, the frequency of the coding limit subband has to be decided by coding criteria. Since the bit rate and the bandwidth are limited, the coding apparatus may discard some information of high frequency subbands. If no information is discarded, the last subband is the coding limit subband.

After the reference sample data 50 is selected, the energy calculator 38 calculates the energy sum contained in the reference sample data 50, and the comparator 42 decides whether or not to detect the reference sample data 50. The partition device 40 divides the reference sample data 50 into several equal width subsample data. Then the energy calculator 38 calculates the energy difference between two adjacent subsample data, and the comparator 42 decides the block length of the window. For example, the energy calculator 38 calculates the energy sum of the reference sample data 50 selected by the subband selector 36. If the energy sum is larger than −60 dB, a transient may exist in the reference sample data 50. In this case, the partition device 40 then divides the subband samples of the reference sample data 50 into six groups of subsample data of equal width. Then the energy calculator 38 calculates the energy difference between two adjacent groups of subsample data, and transfers the result to the comparator 42. If the energy difference between two adjacent subsample data is not larger than 20 dB, then no transient actually occurs between the two adjacent subsample data. In such case, the partition device 40 re-divides the subband samples of the reference sample data 50 into three groups of equal width subsample data. Then the energy calculator 38 calculates the energy difference of the subsample data between two adjacent groups of subsample data, and the comparator 42 determines whether the energy difference is larger than 12 dB. If the energy difference is larger than 12 dB, then it is determined that there is a transient and short windows are selected. If the energy difference is not larger than 12 dB, then long windows are selected.

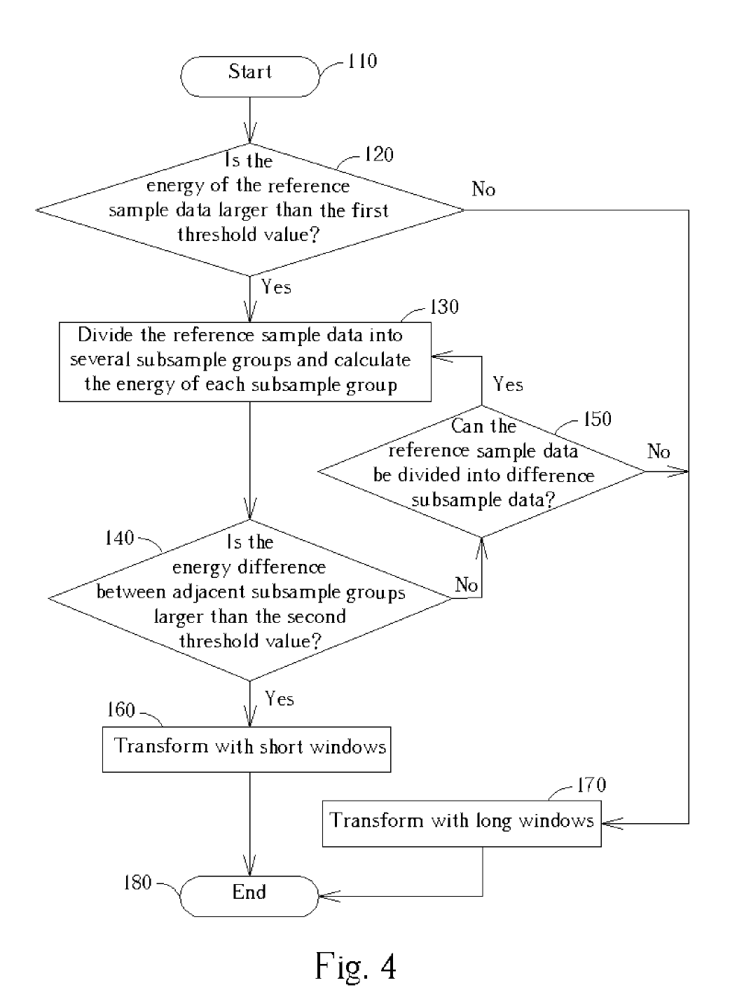

FIG. 4 is a flowchart illustrating how the coding apparatus 30 detects the transient in another embodiment of the present invention. Primarily, a subband coding process is performed to generate a plurality of subband samples corresponding to the input signal 10. Different subband samples correspond to the input signal 10 in different time intervals, and each subband sample includes a plurality of frequency subbands. Then a selection process is performed for deciding the window block length for the next process. The window includes a plurality of weighted values. In the selection process, a plurality of subband samples are selected from the plurality of subband samples as reference sample data, and the window block length is decided according to the energy sum of the frequency subbands of the reference sample data in the predetermined frequency range. Finally a transform process is performed to multiply the plurality of frequency subbands by the plurality of weighted values decided in the selection process for generating a weighted result, and output the output signal by the MDCT according to the weighted result.

Detailed steps of detecting the transient according to this embodiment are illustrated as follows:

Step 110: Start.

Step 120: Is the energy sum of the reference sample data larger than a first threshold value? If yes, proceed step 130, otherwise, proceed step 170.

Step 130: Divide the reference sample data into several equal width subsample groups and calculate the energy of each subsample group.

Step 140: Is the energy difference between two adjacent subsample groups larger than a second threshold value? If yes, proceed step 160, otherwise, proceed step 150.

Step 150: Can the reference sample data be divided into differenct subsample data? If yes, return to step 130, otherwise, proceed step 170.

Step 160: Transform with short windows, then proceed step 180.

Step 170: Transform with long windows, then proceed step 180.

Step 180: End.

Please note that if the energy difference between adjacent subsample groups is not larger than the second threshold value in step 140 and the reference sample data can be divided into different subsample data, the reference sample data will be divided into several different subsample groups in step 130, and compared with the second threshold value again. However, since the subsample groups are different, the second threshold value may be changed during the iterative steps of detecting the transient.

In comparison with the prior art, the present invention provides a coding apparatus and method thereof for deciding the window block length when performing the MDCT. It is worth noting that the present invention determines whether a transient exists by comparing the energy of the frequency subbands generated in encoding. Therefore, the present invention is more economical than the prior art, which uses the psychoacoustic model.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for coding an input signal to an output signal, the method comprising:
performing a subband coding process to produce a plurality of subband samples according to the input signal, different subband samples corresponding to the input signal in different time intervals, each of the subband samples having a plurality of frequency subbands;
performing a selection process to provide a window corresponding to a predetermined block length, the window including a plurality of weighted values, the selection process including selecting subband samples from the plurality of subband samples as reference sample data, and determining the block length of the window according to an energy sum of the frequency subbands of the reference sample data in a predetermined frequency range; and
performing a transform process to multiply the plurality of frequency subbands by the plurality of weighted values of the window determined in the selection process for producing a weighted result, and to generate the output signal by a predetermined algorithm according to the weighted result.

2. The method of claim 1 wherein in the selection process, if the energy sum of the frequency subbands of the reference sample data in the predetermined frequency range is larger than a first threshold value, further execute a first comparing process comprising:
dividing the reference sample data into several subsample data, each subsample data having at least a subband sample; and
calculating an energy difference of the frequency subbands between two adjacent subsample data in the predetermined frequency range, if the energy difference is larger than a second threshold value, using a window of a short block length in the transform process.

3. The method of claim 2 wherein the selection process further comprises:
when performing the first comparing process, if the energy difference of the frequency subbands between two adjacent subsample data in the predetermined frequency range is less than or equal to the second threshold value, performing a second comparing process and let the subsample data in the second comparing process include different subband samples from the subband samples of the subsample data in the first comparing process.

4. The method of claim 3 wherein when performing the second comparing process, a different second threshold value is selected.

5. The method of claim 2 wherein if the energy sum of the frequency subbands of the reference sample data in the predetermined frequency range is less than the first threshold value, then transform with a window of a long block length in the transform process.

6. The method of claim 1 wherein the input signal is a pulse code modulation (PCM) signal.

7. The method of claim 1 wherein the output signal is bit stream.

8. The method of claim 1 wherein the predetermined algorithm is a modified discrete cosine transform (MDCT).

9. A coding apparatus for coding an input signal to an output signal, the coding apparatus comprising:
a polyphase filter bank for producing a plurality of subband samples according to the input signal, different subband samples corresponding to the input signal in different time intervals, each subband sample having a plurality of frequency subbands;
a transient detector connected to the polyphase filter bank for determining a block length of a window, the window including a plurality of weighted values, the transient detector including:
a subband selector for selecting the plurality of subband samples as reference sample data;
an energy calculator connected to the subband selector for calculating an energy sum of the frequency subbands of the reference sample data;
a partition device connected to the subband selector and the energy calculator for dividing the reference sample data into several subsample data, each subsample data having at least a subband sample; and
a comparator connected to the energy calculator for comparing an output value of the energy calculator with a first threshold value, and outputting a signal representing the block length of the window according to a comparing result; and
a coding processing unit connected to the polyphase filter bank and the transient detector for multiplying the plurality of frequency subbands by the plurality of weighted values of the window to generate a weighted result, and generating the output signal by a predetermined algorithm according to the weighted result.

10. The coding apparatus of claim 9 wherein the energy calculator calculates an energy difference of the frequency subbands of two adjacent subsample data, and delivers a result to the comparator for comparing the result with a second threshold value.

11. The coding apparatus of claim 10 wherein the partition device divides the reference sample data into several subsample data according to the result of the comparator, each subsample data including subband samples different from the subband samples of the preceding subsample data.

12. The coding apparatus of claim 9 wherein the input signal is a pulse code modulation (PCM) signal.

13. The coding apparatus of claim 9 wherein the output signal is bit stream.

14. The coding apparatus of claim 9 wherein the predetermined algorithm is a modified discrete cosine transform (MDCT).

15. A method for transient detection when coding an audio signal, the method comprising the following steps:
(a) producing a plurality of subband samples according to the audio signal, different subband samples corresponding to the audio signal in different time intervals, each subband sample including a plurality of frequency subbands;
(b) selecting subband samples from the plurality of subband samples as reference sample data, and calculating an energy sum of the frequency subbands in a predetermined frequency range according to the reference sample data;
(c) if the energy sum of the frequency subbands in the predetermined frequency range is larger than a first threshold value, dividing the reference sample data into several subsample data, each subsample data having at least a subband sample; and
(d) calculating an energy difference of the frequency subbands between two adjacent subsample data in the predetermined frequency range, and according to the energy difference determining whether there is a transient of the audio signal of a time interval corresponding to the subsample data.

16. The method of claim 15 wherein when determining the transient of the audio signal according to the energy difference in step (d), if the energy difference is larger than a second threshold value, determining the audio signal between the two subsample data is the transient.

17. The method of claim 15 wherein in step (d), if the energy difference of the frequency subbands between two adjacent subsample data in the predetermined range is less than the second threshold value, dividing the reference sample data into several subsample data different from the subsample data in step (c) and re-executing step (d).

18. The method of claim 17 wherein when re-executing step (d), a different second threshold value is selected.

19. A transient detector installed in a coding apparatus for detecting whether an audio signal includes a transient, the coding apparatus comprising a polyphase filter bank for producing a plurality of subband samples according to the audio signal, different subband samples corresponding to the audio signal in different time intervals, each subband sample having a plurality of frequency subbands, the transient detector being connected to the polyphase filter bank and comprising:
a subband selector for selecting the plurality of subband samples as a reference sample data;
an energy calculator connected to the subband selector for calculating an energy sum of the frequency subbands of the reference sample data;
a partition device connected to the subband selector and the energy calculator for dividing the reference sample data into several subsample data, each subsample data having at least a subband sample; and
a comparator connected to the energy calculator for comparing an output value of the energy calculator with a first threshold value, and determining whether the audio signal includes a transient according to a comparing result.

20. The transient detector of claim 19 wherein the energy calculator calculates an energy difference of the frequency subbands of two adjacent subsample data, and delivers a result to the comparator for comparing the result with a second threshold value.

21. The transient detector of claim 20 wherein the partition device divides the reference sample data into several subsample data according to the comparing result of the comparator, each subsample data including subband samples different from the subband samples of the preceding subsample data.

22. The transient detector of claim 19 wherein the audio signal is a pulse code modulation (PCM) signal.
